(19) United States
(12) Patent Application Publication
(10) Pub. No.: US 2006/0230657 A1
(43) Pub. Date: Oct. 19, 2006

(54) Rotatable advertising plaque and method of use thereof

(76) Inventor: Christiaan Burger Kotze, Peachtree City, GA (US)

Correspondence Address: WILLIAMSON INTELLECTUAL PROPERTY LAW, LLC, 1870 THE EXCHANGE, SUITE 100, ATLANTA, GA, 30339, US

(21) Appl. No.: 11/406,029

(22) Filed: Apr. 18, 2006

Related U.S. Application Data
(63) Continuation-in-part of application No. 11/109,152, filed on Apr. 19, 2005.

(51) Int. Cl. G03B 25/02

(52) U.S. Cl. 40/454

(57) ABSTRACT

An advertising plaque comprising a panel for receiving an advertisement, a means for articulating the panel, a lenticular screen, and an advertisement, wherein the advertisement has two separate images that can be independently viewed through the lenticular screen by moving the sighting location to selectively bring the images into view. The advertisement can be removed and replaced when desired and the removable plaque can be rotated to permit viewing of both portrait and landscape image orientations. An additional embodiment is a flexible lenticular screen with an advertisement affixed thereto. The alternate screen/advertisement combination is removably secured to a seat via adhesive.

### PRIORITY CLAIM

The present application is a continuation-in-part application to non-provisional patent application Ser. No. 11/109,152, entitled “ROTATABLE ADVERTISING PLAQUE AND METHOD OF USE THEREOF”, filed on Apr. 19, 2005, and claims priority thereto and the full benefit thereof.

### TECHNICAL FIELD

The present invention relates generally to advertising plaques, and more specifically to a rotatable advertising plaque and method of use thereof, wherein the advertising plaque comprises a lenticular screen and may be removably-secured to the rear of an aircraft seat, and wherein the advertising plaque can be rotated through an angle of approximately ninety degrees.

### BACKGROUND OF THE INVENTION

During airline travel, passengers are generally required to remain in their aircraft seat. Since aircraft seats are situated in rows, one behind the other, passengers typically spend significant time facing the rear of the seat in front of them. Accordingly, many advertisers take advantage of such a “confined” audience by placing advertising materials within view and reach of the passengers, typically within a pocket in the rear of each seat. Although the vast majority of onboard airline advertising literature is in the form of magazines, pamphlets, and the like, other devices have been utilized to attempt to provide a means for placing an advertisement in front of a passenger.

For instance, one such device comprises an advertisement on the inside portion of an aircraft seat tray table, wherein the advertisement will be visible once the tray table is lowered. However, such a device is only visible when the tray table is lowered and only if the passenger or cabin attendant does not place food, reading material, computers or other articles thereupon. Since most passengers utilize the surface of the tray table for supporting a variety of such articles, the advertisement on the surface of the tray table will be obscured by the article and, thus, not visible. Additionally, once placed or returned to a stowed position, the advertisement on the tray surface will not be visible. Furthermore, such advertisement devices comprise only a single image, limiting their usefulness, and it would be advantageous to have a device that could display multiple advertisements, thereby to increase exposure and advertising revenue from more sources. With current device, it is only possible to have additional advertisements by changing the existing advertisement.

Another device includes an advertisement on the outside of the tray table. Unfortunately, such an advertisement is only visible when the tray table is in the stowed position, which for many passengers comprises only the first few and last few minutes of the flight. Accordingly, the advertisement is not impressed upon the passenger. Furthermore, because such an advertisement is fixed or non-removable, passengers are forced to look upon what may be considered an offensive or distasteful advertisement. Moreover, such an advertisement only comprises a single image, and is of limited utility.

Yet other devices are mounted within the back of an aircraft seat, either above the tray table or in the storage frame thereof, wherein the latter is obscured by the tray table while it is in the stowed position. Such devices are disadvantageous due to difficulty in changing the advertising message by the aircraft cabin cleaning crew, who must take the time to remove the tray table for access to the advertisement or, alternately, to remove the device from the seat back to insert a new advertisement. Because such devices are mounted within, or fixedly upon, the seat frame, they cannot be changed to accommodate different orientations of advertisement, such as, for exemplary purposes only, portrait or landscape orientations. Furthermore, such constantly visible advertisements could be objectionable to some passengers, comprise only a single image and, unfortunately, cannot be readily removed for stowage and/or repair.

Therefore, it is readily apparent that there is a need for a rotating advertising plaque and method of use thereof, wherein the advertising plaque is removable by the passenger or cabin crew, and wherein the advertising plaque is capable of receiving a replaceable multiple image advertisement that is in either portrait or landscape orientation.

### BRIEF SUMMARY OF THE INVENTION

Briefly described, in a preferred embodiment, the present invention overcomes the above-mentioned disadvantages and meets the recognized need for such a device by providing a removable, rotatable advertising plaque comprising a lenticular screen to provide 3-dimensional, multi-image, morphing and/or holographic images, wherein the advertising plaque is removably attachable to the rear surface of an aircraft seat. The use of a lenticular screen permits the viewing of a number of different images or a sequence of different images, thereby providing different or progressive views.

The rotatable advertising plaque can be selectively positioned above the seat tray table or on the back thereof, and can be removed and stowed when not desired. Replaceable advertisements are inserted from the sides of the plaque frame, or from the top thereof, and are retained by a frictional surface and/or a pressure-exerting member. The advertisements can be in portrait or landscape orientation, wherein the advertising plaque is adapted to rotate ninety degrees to change between the formats, thereby permitting the plaque to accept advertisements in either orientation.

According to its major aspects and broadly stated, the present invention in its preferred form is a rotating advertising plaque comprising a frame and a pivot mechanism, wherein the frame accepts and retains a lenticular screen and a multi-image advertisement, and wherein the advertisement is viewable through the lenticular screen. Since the lenticular screen permits viewing of multiple images contained within a single advertisement by adjusting one's line-of-sight, multiple advertisements can be provided via a single plaque unit. Additionally, the lenticular screen is frictionally held within the frame of the advertising plaque via bowed, compressible members, wherein the lenticular screen is removable for replacement in the event that it becomes damaged, scratched, or worn.

More specifically, the present invention is a rotatable advertising plaque comprising a frame with a lenticular screen and advertisement therein, and further comprising a pivot mechanism. The advertisement and the lenticular screen are retained within the frame via compression holders extending from the back of the frame and located along the edges and or bottom of the frame. The frame comprises slots at the top edge and at least one side edge thereof, wherein the advertisement can be removed/inserted into the frame via the slots. Thus, replacement of the advertisement can be rapidly accomplished during regular aircraft cleaning during air terminal stopovers. The advertisement comprises two graphic images that are concurrently present within the artwork of the advertisement such that when viewed through the lenticular screen from different angles, the different images are selectively seen by the viewer.

An alternate embodiment comprises a flexible lenticular screen to which an advertisement is affixed or coated. No articulation mechanism is required. The screen/advertisement combination is subsequently removably affixed to a seat back.

The present invention includes a pivot mechanism comprising a base and a pivot member. The base further comprises a fastener for removable attachment to the seat back, such as a hook-and-loop fastener, a snap fastener, buckles, or the like. The rotatable advertising plaque can be selectively attached to the back of an airline seat either on the back of the fold-down tray table or on the top portion of the seat above the tray table, wherein the advertising plaque is constantly in view of a traveller, thereby providing constant reinforcement of the advertised message. For those travellers who do not wish to have the advertisement in view, the plaque may be removed and stowed away for use during a later flight.

The images contained within the advertisement are viewable by a traveller seated in the next rearward seat. The traveller can select the desired image for viewing by moving his or her head to the right or left of the advertising plaque. It will be recognized by those skilled in the art that the images could alternately be viewable by moving the viewpoint above or below the advertising plaque.

Accordingly, a feature and advantage of the present invention is its ability to rotate to receive advertisements that are either in landscape or portrait profile.

Another feature and advantage of the present invention is its ability to be removed when not required.

Still another feature and advantage of the present invention is its ability to provide different images selectable by the passenger upon movement of the passenger's viewing location.

Yet another feature and advantage of the present invention is that advertisements can be readily replaced/changed.

Yet still another feature and advantage of the present invention is that it can alternately be positioned on the upper back of an aircraft seat or on the back of the tray table.

A further feature and advantage of the present invention is that it is lightweight and compact.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1A is a plan view of a rotatable advertising plaque according to a preferred embodiment of the present invention, disposed on the back of an aircraft seat tray table;

FIG. 1B is a plan view of a rotatable advertising plaque according to a preferred embodiment of the present invention, disposed on an aircraft seat above the seat tray table;

FIG. 2 is an exploded perspective view of a rotatable advertising plaque according to a preferred embodiment of the present invention;

FIG. 3 is a perspective view of a rotatable advertising plaque according to a preferred embodiment of the present invention, shown rotated;

FIG. 4 is a side view of a rotatable advertising plaque according to an alternate embodiment of the present invention;

FIG. 5A is a perspective view of a rotatable advertising plaque according to a preferred embodiment of the present invention, shown in use by a traveller viewing a first graphic;

FIG. 5B is a perspective view of a rotatable advertising plaque according to a preferred embodiment of the present invention depicting a first graphic;

FIG. 5C is a perspective view of a rotatable advertising plaque according to a preferred embodiment of the present invention, shown in use by a traveller viewing a second graphic;

FIG. 5D is a perspective view of an articulating advertising plaque according to a preferred embodiment of the present invention depicting a second graphic; and,

FIG. 6 is a perspective view of an advertising plaque according to an alternate embodiment of the present invention.

### DETAILED DESCRIPTION OF THE PREFERRED AND SELECTED ALTERNATIVE EMBODIMENTS

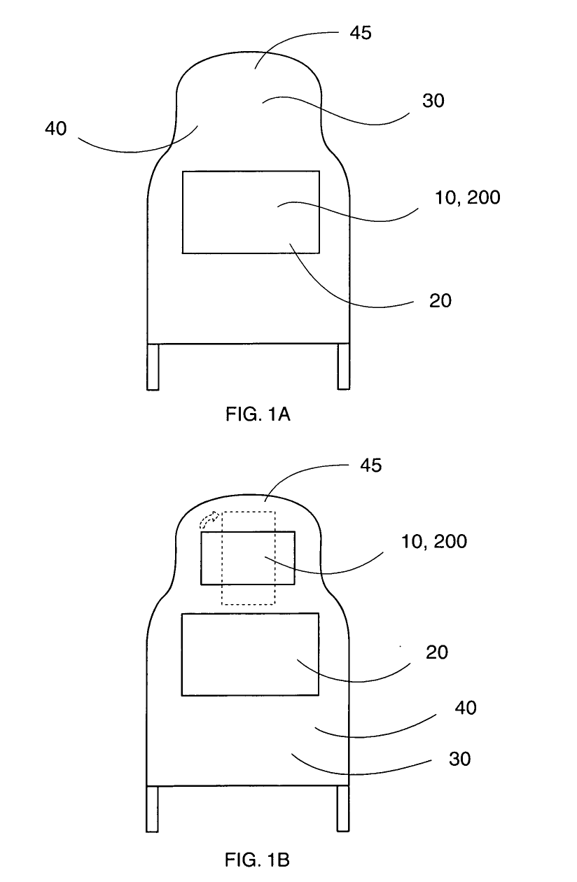

In describing the preferred and selected alternate embodiments of the present invention, as illustrated in FIGS. 1A-6, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1A-5D, the present invention in a preferred embodiment is rotatable advertising plaque 10, preferably comprising frame 50, lenticular screen 60, advertisement 110 and pivot mechanism 120. Frame 50 preferably comprises frame front 55, top edge 52, bottom edge 54, left edge 56, right edge 58, back 90 and compression holders 100. Top edge 52 preferably comprises top slot 70 and right edge 58 comprises side slot 80. It will be recognized by those skilled in the art that slots 70, 80 could be disposed in bottom edge 54 or left edge 56, respectively.

Compression holders 100 are preferably carried by back 90, wherein one or more compression holders 100 are preferably disposed proximate either left edge 56 or right edge 58 of frame 50, and one or more compression holders 100 are preferably disposed proximate top edge 52 or bottom edge 54 of frame 50.

Advertisement 110 preferably comprises first graphic 140 and second graphic 150, wherein graphics 140 and 150 are preferably concurrently present within advertisement 110, and wherein first graphic 140 or second graphic 150 can preferably be selectively viewed through lenticular screen 60.

Pivot mechanism 120 preferably comprises base 125 and pivot member 130, wherein base 125 preferably comprises fastener 127 disposed thereon, and wherein fastener 127 preferably cooperatively engages seat back 40, thereby securing rotatable advertising plaque 10 to seat 30. For exemplary purposes only, fastener 127 could comprise a hook-and-loop fastener, snaps, clips, belts, buckles, removable adhesive, or the like. Pivot member 130 preferably enables selection between portrait and landscape orientations, wherein frame 50 is retained in the selected orientation by pivot mechanism 120.

Advertisement 110 is preferably disposed behind lenticular screen 60, wherein advertisement 110 and lenticular screen 60 are preferably retained within frame 50 via compression holders 100, wherein compression holders 100 exert force against advertisement 110 and lenticular screen 60, preferably pressing advertisement 110 and lenticular screen 60 against frame front 55. It will be recognized by those skilled in the art that alternative means to compression holders 100 for retention of advertisement 110 and/or lenticular screen 60 could be utilized, such as, for exemplary purposes only, frictional materials.

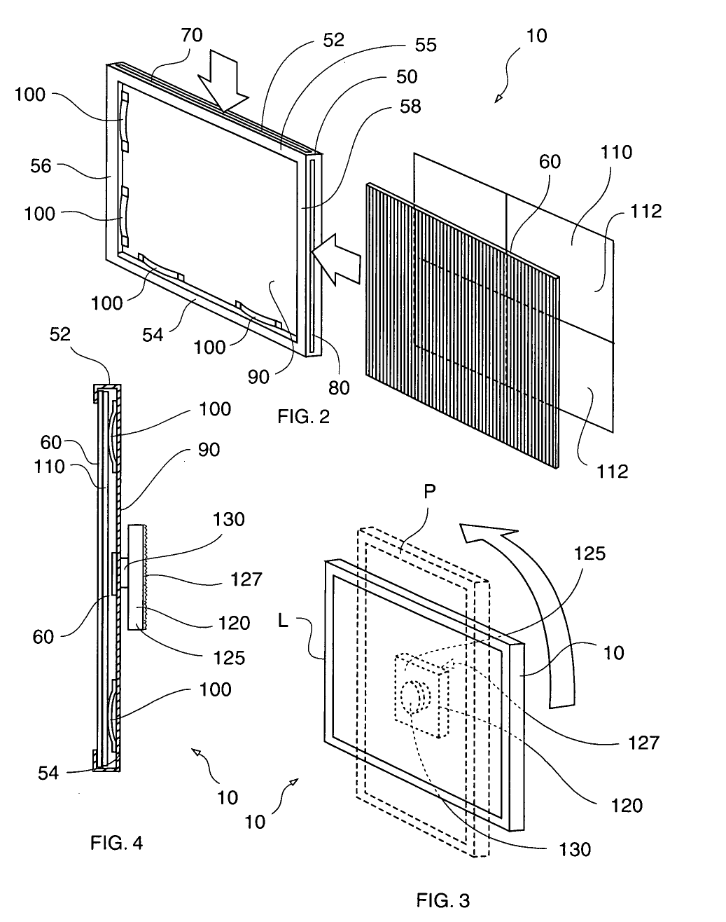

As best illustrated in FIG. 2, replacement of advertisement 110 is preferably effectuated by removal of advertisement 110 from frame 50, followed by insertion of a new advertisement 110 between lenticular screen 60 and back 90, via either top slot 70 or side slot 80, wherein compression holders 100 preferably frictionally retain advertisement 110 and lenticular screen 60 within frame 50. Thus, replacement of advertisement 110 and/or lenticular screen 60 can be rapidly accomplished during regular aircraft cleaning by removing advertisement 110 and/or lenticular screen 60, and replacing same with a new advertisement 110 and/or lenticular screen 60.

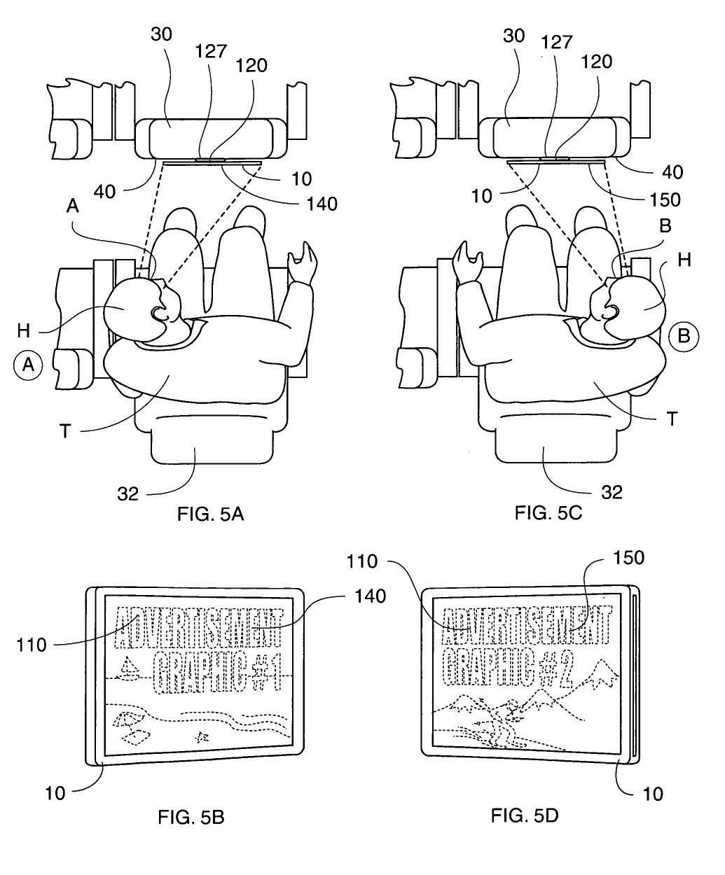

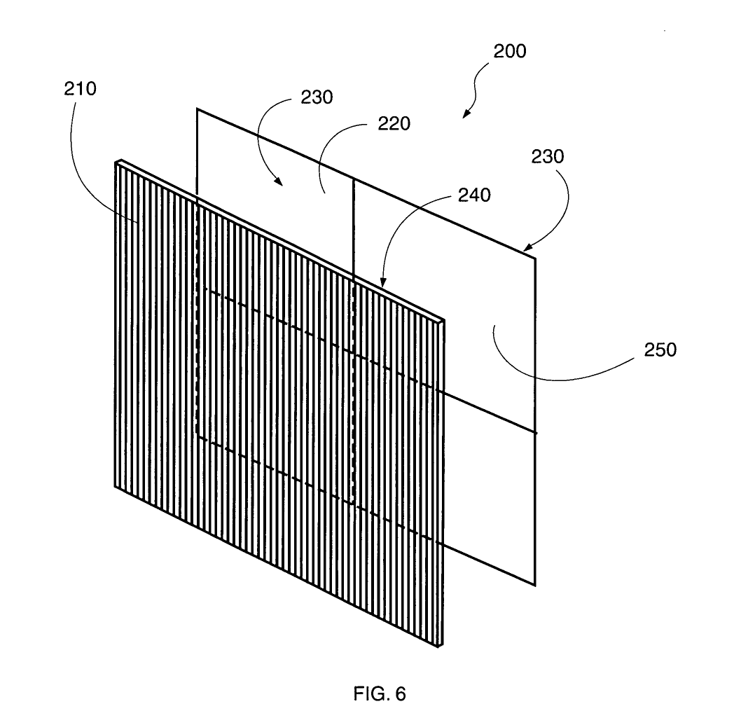

Rotatable advertising plaque 10 can be selectively disposed on tray table 20 or on seat back top 45, wherein advertising plaque 10 can preferably be viewed by traveller T from his/her location in his/her rearward seat 32 (best shown in FIGS. 5A and 5B). When viewing advertising plaque 10, traveller T preferably selectively views first graphic 140 or second graphic 150 by moving his/her head H to viewing location A or B, respectively (i.e., changing or adjusting his/her line-of-sight).

As best illustrated in FIG. 2, it is envisioned in an alternate embodiment of the present invention that advertisement 110 could comprise several sections 112, each with different multi-image graphics therewithin.

Referring now more specifically to FIG. 6, illustrated therein is an alternate embodiment of device 10, wherein the alternate embodiment of FIG. 6 is substantially equivalent in form and function to that of the preferred embodiment detailed and illustrated in FIGS. 1-5D except as hereinafter specifically referenced. Specifically, the embodiment of FIG. 6 comprises flexible advertising plaque 200, wherein flexible advertising plaque 200 comprises lenticular screen 210, advertisement 220 and adhesive 230. As described hereinabove, advertisement 220 could comprise a plurality of sections 250 with different multi-image graphics therewithin.

Adhesive 230 could comprise any removable adhesive that secures advertising plaque 200 to the cloth material of seat back 40 (best shown in FIGS. 1A and 1B). Advertisement 220 can be removable affixed to lenticular screen 210, thereby permitting removal/replacement of advertisement while reutilizing lenticular screen 210, or alternately, advertisement 220 could be coated onto reverse 240 of lenticular screen 210.

Flexible advertising plaque 200 is particularly suited for quick and easy removal/replacement on seat back 40 (best shown in FIGS. 1A and 1B), thereby permitting changing of advertisement 220 in a minimum amount of time. Such facile replacement permits a large number of advertisements 220 to be replaced in a short period of time, such as those removably affixed to aircraft seats 30 as depicted in FIGS. 1A and 1B.

Further, flexible advertising plaque 200 could be utilized in long corridors that are regularly traversed by persons travelling therethrough, wherein a sequence of advertisements is displayed as persons pass flexible advertising plaque 200. Such a sequence of advertisements could greatly increase the revenue derived from selling advertisement locations in such long corridors by multiplying the number of advertisements at a given location.

It is further envisioned in an alternate embodiment of the present invention that rotatable advertising plaque 10 could be non-rectangular in shape, such as, for exemplary purposes only, round, square, pentagonal, or the like.

It yet another alternate embodiment of the present invention, it is contemplated that advertising plaque 10 could be utilized on seats in trains, buses, ships, etc.

It is still further contemplated in an alternate embodiment of the present invention that advertising plaque 10 could comprise pivot mechanism 120, wherein pivot mechanism 120 permits articulation in addition to rotation wherein advertising plaque 10 can be selectively moved left/right, up/down, or positions therebetween.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. An advertising plaque comprising:
a flexible lenticular screen comprising an obverse and a reverse; and
an advertisement disposed proximate said reverse of said flexible lenticular screen.

2. The advertising plaque of claim 1, wherein said advertisement is removably secured to said flexible lenticular screen.

3. The advertising plaque of claim 1, wherein said advertisement is coated on said reverse.

4. The advertising plaque of claim 1, wherein said advertisement comprises at least two images, and wherein each of said at least two images is independently viewable through said lenticular screen.

5. The advertising plaque of claim 1, further comprising a means for removably securing said advertising plaque to an aircraft seat.

6. The advertising plaque of claim 5, wherein said means for removably securing comprises a fastener selected from the group consisting of hook-and-loop fasteners, snap fasteners, clip fasteners, belt fasteners, buckle fasteners, removable adhesive, and combinations thereof.

7. The advertising plaque of claim 1, wherein said advertising plaque comprises a panel portion and a means for rotating said panel portion, wherein said means for rotating comprises a means for articulating between landscape and portrait orientations.

8. The advertising plaque of claim 7, further comprising a slot in at least one edge of said panel portion.

9. The advertising plaque of claim 8, wherein said lenticular screen is replaceable.

10. The advertising plaque of claim 9, wherein said panel comprises compression holders, wherein said advertisement is secured within said panel via said compression holders.

11. The advertising plaque of claim 7, further comprising a first slot in a top edge of said panel portion and a second slot in a side edge of said panel portion.

12. The advertising plaque of claim 1, wherein said advertisement comprises a plurality of multi-image segments.

13. A method of advertising, said method comprising the step of:
installing an advertising plaque on a first seat, said plaque comprising a flexible lenticular screen, wherein said advertising plaque is visible from a second seat, and wherein said second seat faces a rear portion of said first seat.

14. The method of claim 13, further comprising the step of:
removing said advertising plaque.

15. The method of claim 13, further comprising the step of:
inserting an advertisement into said advertising plaque.

16. The method of claim 15, wherein said advertisement comprises at least two images.

17. The method of claim 16, further comprising the step of:
independently viewing each of said at least two images through said lenticular screen.

18. The method of claim 13, further comprising the step of:
articulating said flexible lenticular screen between landscape and portrait orientations.

19. An advertising plaque comprising:
a flexible lenticular screen; and
an advertisement; wherein said advertisement is removably affixed to said lenticular screen.

20. The advertising plaque of claim 19, further comprising a means for removably affixing said advertising plaque to a seat.
